(19) United States
(12) Patent Application Publication
(10) Pub. No.: US 2017/0231344 A1
(43) Pub. Date: Aug. 17, 2017

(54) METHOD AND ASSOCIATED SYSTEM FOR MANUFACTURING DO-IT-YOURSELF PAPERBOARD SMARTPHONE CASES AND CONTAINERS

(71) Applicant: Edward A. Zumbiel, Union, KY (US)

(72) Inventor: Edward A. Zumbiel, Union, KY (US)

(21) Appl. No.: 15/407,525

(22) Filed: Jan. 17, 2017

Related U.S. Application Data
(60) Provisional application No. 62/294,508, filed on Feb. 12, 2016.

(51) Int. Cl. A45C 11/00; B65D 5/42; H04B 1/3888; B41J 2/01; B05D 5/04; B65B 43/10; B65D 5/56

(52) U.S. Cl. CPC A45C 11/00; B65B 43/10; B65D 5/4266; B65D 5/563; B41J 2/01; B05D 5/04; H04B 1/3888; A45C 2011/002

(57) ABSTRACT

The invention relates to paperboard smartphone cases and paperboard containers, and more particularly, to do-it yourself paperboard smartphone cases and paperboard containers manufactured to enable households and small businesses to produce custom smartphone cases and product containers using inexpensive, readily available inkjet printing equipment and associated methods/systems for doing so.

This claims the benefit of U.S. Provisional Patent Application Ser. No. 62/294,508, filed Feb. 12, 2016 and hereby incorporated by reference in its entirety.

### BACKGROUND OF THE INVENTION

The invention relates to do-it-yourself paperboard smartphone case/container kits which are manufactured to enable consumers to produce items such as custom smartphone cases on readily available inkjet printers. The user creates digital images and desired text on a computer. The user then connects her computer to a website featuring a smartphone case/container template corresponding to the desired smartphone case style. With compatible, engineered smartphone case carrier blanks in the printer, the desired image is printed thereon. The user then removes the flat, printed smartphone case from the carrier blank and folds the case on its scores to form a three dimensional smartphone case bearing the individualized image.

Smartphone cases and paperboard containers are extremely useful both for adding physical protection to their contents, e.g. an electronic device, and for adding style/flair to contents that could otherwise be generic in appearance.

As is conventionally known in the paperboard packaging industry, folding paperboard containers and dimensional paperboard containers are manufactured on highly specialized equipment, operated by skilled technicians, who use the equipment to convert webs of cellulosic substrates into printed, die-cut and glued finished products (e.g. paperboard containers) which can then, for example, be filled by users with specific articles.

As is conventionally known in the consumer electronics industry, smartphones have become an ubiquitous bodily appendage; and, cases for smartphones are nearly as popular as the smartphones themselves. It is also conventionally known in the consumer electronics industry that there are a limited number of options from major smartphone manufacturers with respect to smartphone colors and graphic designs. There are however an almost infinite variety of colors, patterns, graphic designs, and protective features made available to consumers by a multitude of smartphone case manufacturers. Smartphone cases generally fall into one of two categories: (1) those manufactured from an extensible substance, e.g. rubber, that can be stretched and/or wrapped around the smartphone exterior; and, (2) those manufactured from a rigid substance, e.g. ABS plastic, with interlocking pieces which can be coupled/fastened around the exterior of the smartphone. The industrial equipment required to fabricate plastic, rubber and/or metal parts for smartphone cases is known to be highly specialized and is further known to require skilled technicians to operate.

Despite the abundance of materials and designs currently offered for sale by manufacturers of smartphone cases, it is often desirable for consumers to have the ability to design their own smartphone cases. Consumers may, for example, prefer to place photographs of their children, pets, etc. on the exteriors of their smartphone cases rather than utilizing off-the-shelf designs. And, there are an abundance of firms that, for a fee, will allow consumers to personalize smartphone cases with photographs and other graphic designs. Even with an abundance of firms that can personalize a wide variety of smartphone cases, all prior known art and methods for producing personalized smartphone cases suffer from certain drawbacks.

Time is the first drawback. Under the most expeditious known art, to obtain a smartphone case with custom graphics, a consumer is required to upload a photo or graphic design over the Internet and wait for the manufacturer of the personalized case to transfer the consumer's digital image to the desired smartphone case. After the manufacturer produces the custom case, the consumer must wait for the manufacturer's shipper, e.g. FedEx™, to physically deliver the smartphone case to the consumer. If, for example, a consumer were to purchase a designer handbag late in the afternoon with the intent to “accessorize” her outfit with a matching smartphone case for an early evening happy hour, it would be next to impossible to design, manufacture, and transport the matching smartphone case in time for happy hour if the consumer utilized known art and methods for acquiring a custom smartphone case.

The cost to personalize a smartphone case is a drawback. Consumers ordering custom smartphone cases tend to order quantities of, literally, one. That is, they do not order quantities sufficient to achieve significant economies of scale. Personalized cases therefore tend to be much more expensive to produce and purchase than comparable mass-produced designs.

The lack of privacy associated with having a design produced and shipped by a third-party is a drawback. Consumers may want images transferred to their smartphone cases yet desire that the images/smartphone cases remain private—out of either real or imagined privacy concerns. Once an image is provided to a third party for manufacturing and shipping, it is likely that the image will be seen by other human beings that are unknown to the consumer seeking to customize her smartphone case. In order to overcome privacy concerns, consumers could purchase commercial equipment capable of printing three dimensional, rigid materials such as smartphone cases and the like, but said equipment would be prohibitively expensive—especially for a consumer who only occasionally replaces her smartphone cover.

The destructive effects of non-renewable products on the environment are well understood, and many consumers want to avoid purchasing products made from non-renewable materials, such as imprinted plastic smartphone cases.

It is well understood that certain demographic groups, e.g. teenagers, are notoriously fickle with respect to taste and fashion. It is also well understood that certain demographic groups have short attention spans/memories. Known art for manufacturing smartphone cases (especially for use as fashion accessories and/or political statements) is woefully inadequate for keeping users in sync with what is, at the moment, trending on social media. One minute, the smartphone case fashion might be a rainbow, the next it could be the French flag, and the following day it might be a catch-phrase mumbled by a drunk celebrity being placed under arrest. For the consumer attempting to maintain a fashion-forward, socially and/or politically relevant smartphone case, creating custom graphics, uploading to a manufacturer and waiting a period of days for delivery is a solution that utterly fails to keep pace with the fast changing, and quickly forgotten, events, sound-bites and fashions of the 21^{st} century.

The “last century” appearance of known art do-it-yourself smartphone case decoration techniques is a drawback. As is conventionally known, there are numerous do-it-yourself techniques that consumers can utilize to decorate their smartphones and smartphone cases without waiting for a professional manufacturer to transfer a digital image onto the smartphone case. For example, 20^{th} century magic-markers, paint, fingernail polish, pressure sensitive labels (stickers) and any number of “analog” embellishments can be added to a consumer's smartphone and/or smartphone case. There is also the option to purchase clear plastic smartphone cases which allow consumers to place photographs and other images between the backs of their smartphones and the smartphone cases. While the insertion of photographs in “windows” on the backs of smartphones may appeal to some, it is a decidedly two-dimensional solution to a three dimensional problem. With the clear-case-inserted-photo prior art, the consumer's image (1) remains buried beneath the surface of the case rather than becoming a part of the case itself, and (2) remains in two dimensions rather than enveloping the entire smartphone in custom graphics and neatly conforming to its contours.

The prior do-it-yourself art involving the literal cutting, folding, and taping/gluing of pre-decorated cellulosic material around a smartphone, in a manner not unlike constructing a protective book cover from a kraft-paper grocery sack is a drawback. Unlike books, smartphones have touch screens, camera lenses, light monitors, microphones, volume controls, fingerprint readers, pulse monitors, etc. To maintain the full functionality of today's smartphones, a consumer's do-it-yourself cellulosic phone-wrap should not interfere with any of the smartphone's sensors, microphones, etc. A consumer attempting to create her own custom printed smartphone case from a cellulosic material would be forced to carve-out access to the smartphone's many controls with either a razor blade, scissors, or knife; under the best of circumstances, making a custom, fully functioning, smartphone cover from cellulosic material would be a time consuming, painstaking combination of engineering and origami.

### SUMMARY OF THE INVENTION

These and other drawbacks in the prior art have been addressed and overcome with this invention which in various embodiments includes raw material, manufacturing methods and systems to enable consumers to produce quickly, efficiently, and economically, fully functioning, environmentally friendly, do-it-yourself paperboard smartphone cases and paperboard containers.

In a first embodiment of this invention, an unprinted web or sheet of paperboard is die-cut into dimensions suitable for use with conventional home and business inkjet printers, e.g. 8.5×11 inches. The interior of the dimensionally appropriate die-cut blank (hereinafter referred to as the “carrier blank”) is further die-cut and scored to correspond to various smartphone case and other dimensional product styles (hereinafter referred to as the “smartphone case flat” or “SCF”). The die-cut and scored SCF remains attached to the carrier blank through an engineered series of cuts and ties, sufficient in size, number and orientation to keep the SCF connected to the carrier blank while the carrier blank is fed through an ink jet printer. After the SCF has been printed, the engineered ties allow the consumer to separate the printed SCF from the unprinted carrier blank without either (1) damaging the SCF, or (2) leaving visually unattractive ragged edges on the SCF (and ultimately the finished smartphone case).

In another embodiment of the invention, the substrate is manufactured from synthetic, rather than cellulosic, paperboard.

In another embodiment of this invention, the final substrate is a laminate of two or more substrates, either or all of which could be cellulosic, synthetic, film-based, etc.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a cross-sectional view of an exemplary inkjet printer;

FIG. 2 is a top plan view of one embodiment of a smartphone case flat within a carrier blank according to this invention; and

FIG. 3 is a perspective view after the carrier blank has passed through a printer and the smartphone case flat has been printed on and folded into a smartphone case and a smartphone inserted into a three dimensional smartphone case/container.

### DETAILED DESCRIPTION OF THE INVENTION

According to various embodiments of this invention, a paperboard smartphone case and/or container 10 can be produced according to the following steps and shown in the accompanying drawings.

Initially, a user may purchase a kit or supply of printable smartphone case flats (SCFs) 10. Included in the kit are several complete carrier blanks 12, each of which may be comprised of regulation sized paperboard sheets (e.g. 8.5×11 inches) which have been (1) pre-cut and pre-scored to correspond to a particular smartphone case and/or container style; and/or (2) pre-treated with an adhesive and a release liner. Each carrier blank 12 contains one or more smartphone case/container flats (SCFs) 10.

The user may then create digital images 18, including pictures, design elements and text via a smart phone, digital camera, scanner, internet download, personal computer (PC) or tablet and send same to a PC or tablet for processing, cropping, re-sizing and other operations as needed in connection with the creation of two dimensional graphics according to this invention.

The user may then access a website with her PC, smartphone, tablet, etc. and locate a smartphone case/container template corresponding to the particular case style or styles in the kit, e.g. an Apple iPhone6™ case.

The user may then place digital images 18 including photographs, text, backgrounds, etc. onto the on-line carton template found on the website. Once satisfied with the carton design, the user sends the digital template image 18 to an inkjet printer 14 just as would be done with any other desktop print job. The user loads compatible smartphone case/container carrier blanks 12 from the kit 9 into the inkjet printer's paper tray 17, and then prints the desired template image 18 on the SCF portion 10 of the carrier blank 12.

The user may then remove an entire, intact, carrier blank 12 and still-connected SCF 10 from the printer 14, and subsequently remove the printed SCF 10 from the carrier blank 12 by manually breaking the ties which attach the SCF 10 to the carrier blank 12.

Following the instructions contained with the kit 9, the user folds the printed SCF 10 along score lines, removes the adhesive release liner from the adhesive, and then permanently connects panels of the printed SCF 10 together to form a finished, three dimensional, printed smartphone case boa into which the consumer can insert a smartphone 16.

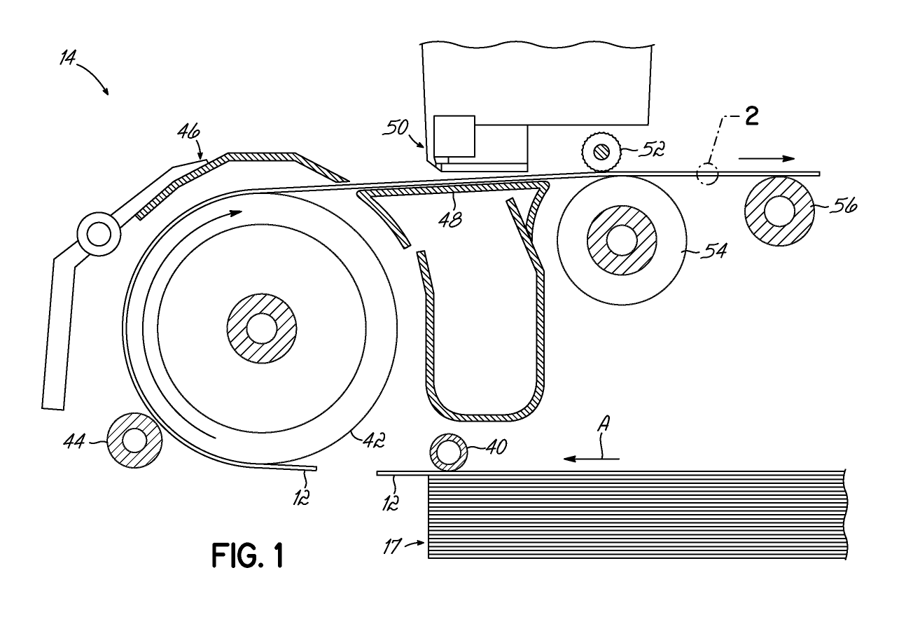

Referring to FIG. 1, a typical inkjet printer 14 is shown in cross section. A supply of carrier blanks 12 is loaded into the printer 14 on a printer tray 17 or other receptacle. The carrier blanks 12 are typically oriented in a similar fashion relative to each other and a topmost carrier blank 12 is dispensed from the supply of carrier blanks 12 by a rotating pick-up roller 40 in frictional contact with a face of the carrier blank 12. Due to frictional interaction between the standard inkjet printer pick-up roller 40 and the substrate, in this case a carrier blank 12, the coefficient of friction on the surface of the carrier blank 12 is important to the successful processing and printing of the carrier blank 12 by the inkjet printer 14.

The carrier blank 12 dispatched from the supply of carrier blanks 10 in direction of arrow A by the pick-up roller and fed directly to a rotating drum 42 which, according to many inkjet printer designs, is positioned relative to one or more contact rollers 44 and a guide 46 or shield mounted on the periphery of the drum 42. The carrier blank 12 is discharged from the rotating drum 42 onto a printing platen 48 or support surface. The printing platen 48 is positioned relative to a print head 50 on an opposite face of the carrier blank 12. As is well known in inkjet printing technology, the print head 50 propels droplets of ink onto the carrier blank 12 in a predefined pattern and arrangement according to the user's selected and designed image 18 for the associated carton style and template.

After the carrier blank 12 receives the printed image from the print head 50, it is discharged from the inkjet printer 14 by counter-rotating discharge rollers 52, 54, a support roller 56 or other associated mechanisms as is well known in the inkjet printing art.

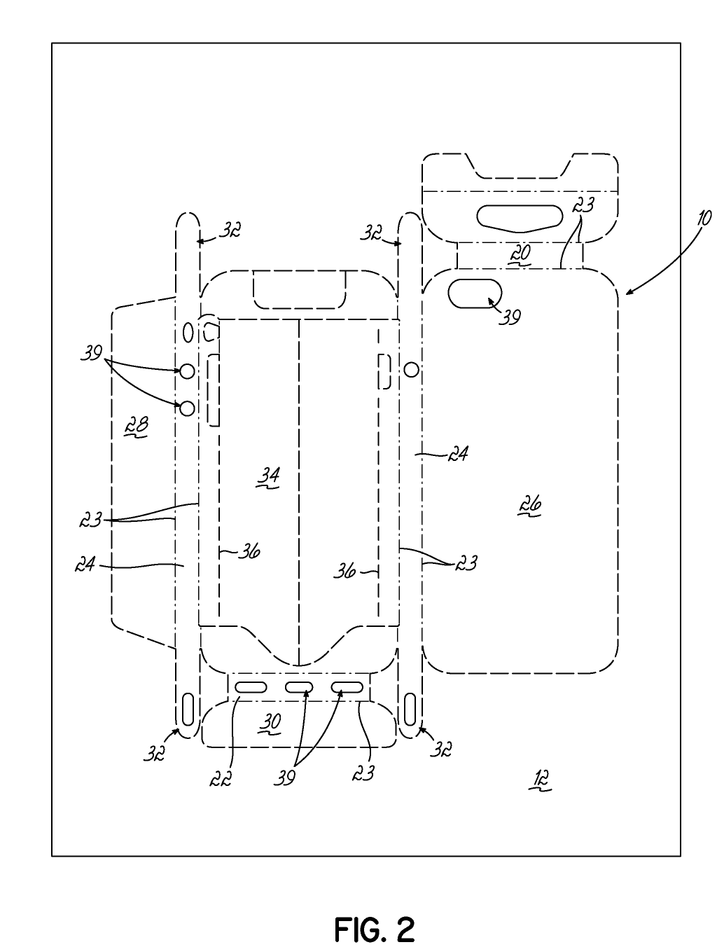

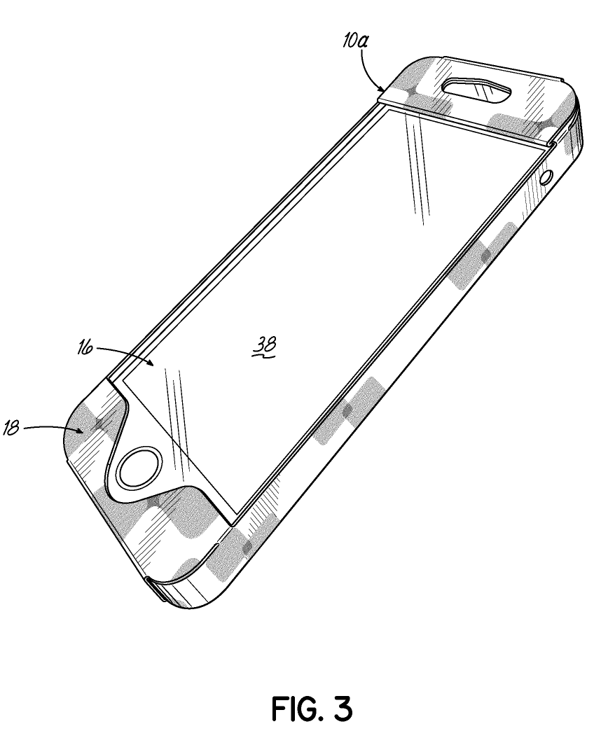

In one embodiment, the smartphone case flat of FIG. 2 includes a top end panel 20, a bottom end panel 22, two side panels 24, a back panel 26, and two glue flaps 28, 30 (one glue flap 28 is attached to one of the side panels 24 by one of various fold or score lines 23 to form a manufacturer's seam and the other 30 attached to the bottom end panel 22 by one of various fold or score lines 23 to form a case closure device upon contact with the bottom end panel 22). On opposite ends of each side panel 24 are dust flaps 32 which are inserted between, and held in place by, the radial corners of the smartphone 16 and the smartphone case's top or bottom end panels 20, 22 to form the radial corners of the erected smartphone case boa (FIG. 3).

The SCF 10 also includes a removable face panel 34 that is positioned between the side dust flaps 32. The face panel 34 is removed from the SCF 10 by bordering tear lines 36 to expose a face 38 of the phone 16 in the erected case boa as shown in FIG. 3. Various holes or other features 39 may be included in the SCF 10 for access to buttons and other components on the phone 16 when it is in the case 10a.

The paperboard smartphone case flat SCF 10 and associated components are but one example of a paperboard container style that may be employed within the scope of this invention. Moreover, one or more SCFs 10 of the same or different container styles may be included on a single carrier blank 12. Furthermore, a single container style may have discrete components (e.g., a lid and a base) included on the same or different carrier blanks 12. Moreover, different designs of the SCF 10 may be utilized with different styles or models of phones 16 within this invention.

While various embodiments of this invention are described relative to an inkjet printer 14, the invention is not limited to only the use of an inkjet printer. However, as an inkjet printer is the most common type of residential printer, it is envisioned that this invention will most commonly be practiced with an inkjet printer 14. As is commonly understood, an inkjet printer is a type of computer printer that creates an image by depositing droplets of ink onto paper. Inkjet printers are often considered the most commonly used type of printer and range from small inexpensive consumer models to very large professional machines that can cost tens of thousands of dollars.

From the above disclosure of the general principles of this invention and the preceding detailed description of at least one embodiment, those skilled in the art will readily comprehend the various modifications to which this invention is susceptible. Therefore, I desire to be limited only by the scope of the following claims and equivalents thereof.

I claim:

1. A method of producing a do-it-yourself smartphone container comprising the steps of:
selecting a container style;
acquiring a carrier blank associated with the container style;
loading the carrier blank with connected container into a printer;
selecting an image to be displayed on the container according to the case/container style;
printing the image on the container blank with the printer;
removing an imaged container from the carrier blank; and,
erecting the container from the imaged container flat.

2. The method of claim 1 wherein a template associated with the container style is accessed; an image is applied to the template to produce a template image; and the template image is printed on the container with the printer.

3. The method of claim 1 wherein the steps are performed in the recited order of claim 1.

4. The method of claim 1 wherein the printer is a residential inkjet printer.

5. The method of claim 1 wherein the accessing step further comprises:
remotely accessing an internet website where a plurality of templates for a plurality of smartphone and/or container styles are available; and,
selecting the template associated with the smartphone container style.

6. The method of claim 1 wherein the production of the carrier blank further comprises:
a substrate produced from cellulosic material having a density greater than twenty five pounds per thousand square feet but less than fifty five pounds per thousand square feet;
a substrate with a caliper greater than 0.011 inches but less than 0.016 inches;
a carrier blank with a perforation around the entire perimeter of the smartphone container portion of the carrier blank;
the perforation comprising a combination of ties and spaces with no less than 30% of the total linear surface area of the perimeter perforation comprised of perforation ties;
said perimeter perforation ties to be no less than 0.008 inches in length, and no more than 0.012 inches in length, and spaced no more than 0.012 inches from each other along the perimeter perforation;
the perimeter perforation further comprising intermittent reinforcement ties no less than 0.030 inches in length, and no more than 0.038 inches in length placed in-line with the perimeter perforation ties such that the perimeter perforations formed by the combination of ties between 0.008 and 0.012 inches and larger reinforcement ties when aligned either obliquely or parallel to the grain direction of the cellulosic substrate require between 8 and 25 millinewtons (mN) of force to tear a length of 43 millimeters of the perforated cellulosic substrate, and that the perimeter perforations formed by the combination of ties between 0.008 and 0.012 inches and larger reinforcement ties when aligned perpendicular to the grain direction of the cellulosic substrate require between 8 and 28 mN of force to tear a length of 43 millimeters of the perforated cellulosic substrate.

7. The method of claim 6 wherein the cellulosic substrate is comprised of recycled cellulosic fibers.

8. The method of claim 1 wherein the erecting step further comprises:
folding the smartphone container flat along pre-defined fold lines on the flat.

9. The method of claim 8 further comprising:
removing one or more release liners, covering one or more adhesive lines, from the smartphone container flat; and,
adhering one or more portions of the smartphone container to one or more adhesives lines.

10. The method of claim 1 wherein the smartphone container is selected from the group of synthetic paperboard, cellulosic paperboard, film based substrate and laminates of at least two of these materials.

11. The method of claim 1 further comprising:
application of a coating to the carrier blank flat to increase the coefficient of friction of the blank prior to the loading step to increase the compatibility of the blank with the printer.

12. The method of claim 1 further comprising:
application of a microporous coating to the smartphone case to facilitate adherence and/or coagulation of inks applied by the printer to the smartphone case flat during the printing step.

13. The method of claim 1 wherein the blank is a laminate.

14. The method of claim 1 wherein the smartphone container flat includes disparate and complementary components of the smartphone container.

15. The method of claim 1 wherein all panels of the smartphone container are foldably connected to each other.

16. The method of claim 1 wherein all visible panels of the smartphone case, subsequent to insertion of a smartphone into the erected case, are formed from the same side of the smartphone case flat.

17. The method of claim 1 wherein the longitudinal side panels of the smartphone container are formed by a double ply z-fold and form vertical side walls for the smartphone container, one panel of each said z-fold serving as a horizontal base against which the back of the smartphone rests subsequent to erection of the case and insertion of the smartphone.

18. The method of claim 1 wherein the longitudinal side panels formed by a double ply z-fold create a longitudinal cavity of greater than 1/64 of an inch between the two nearly vertical side by side panels of the z-fold.

19. The method of claim 18 wherein a portion of the inner-ply of the double ply z-fold is removed to allow smartphone buttons and/or other smartphone protrusions to extend into the longitudinal cavity.

20. The method of claim 19 wherein either bosses or embosses are placed on the outer ply of the double ply z-fold panel in juxtaposition with the smartphone buttons and z-fold inner ply cut-outs.

21. The method of claim 1 wherein a folded, connected end panel forms a pocket into which the smartphone is inserted.

22. The method of claim 21 wherein there are no exposed die-cut edges of paperboard that can come into contact with the display panel of the smartphone as the smartphone is inserted into the pocket of the smartphone container.
